(19) United States
(12) Patent Application Publication
(10) Pub. No.: US 2024/0269631 A1
(43) Pub. Date: Aug. 15, 2024

(54) DEVICE FOR MIXING A BEVERAGE WITH A GAS

(71) Applicant: mittemitte GmbH, Berlin (DE)

(72) Inventors: Thiebaut KIENTZ, Berlin (DE); Wiebe WAGEMANS, Berlin (DE)

(73) Assignee: mittemitte GmbH, Berlin (DE)

(21) Appl. No.: 18/566,650

(22) PCT Filed: May 31, 2022
(86) PCT No.: PCT/EP2022/064832

§ 371 Date: Dec. 3, 2023

(30) Foreign Application Priority Data
Jun. 4, 2021 (EP) 21177824.6

(51) Int. Cl. B01F 35/21; A23L 2/54; B01F 23/2361; B01F 23/237; B01F 35/22; B01F 101/14

(52) U.S. Cl. CPC B01F 35/2113; A23L 2/54; B01F 23/23611; B01F 23/237621; B01F 35/2205; B01F 2101/14

(57) ABSTRACT

The invention relates to a device (5) for mixing a beverage with a gas, comprising a gas providing unit (101), a pressure indication device (50) fluidically connectable with a gas cartridge (100) of the gas providing unit (101), such that the first pressure prevails in the pressure indication device (50), and a gas line (7), such that the gas is feedable in a liquid container (9) via the gas line (7), such that the beverage is mixed with the gas when the beverage resides in the liquid container (9). The pressure indication device (50) is configured to be at least in a first state indicating a high quantity of gas in the gas cartridge (100) and in a second state indicating a low quantity of gas in the gas cartridge (100). The state of the pressure indication device (50) indicates whether the first pressure is above or below a predefined threshold.

The invention is related to a device for mixing a beverage with a gas. In particular, the invention is related to a device for mixing water, particularly drinking water, with gaseous CO₂.

A device for mixing a beverage with a gas can be a home carbonation device. “Carbonation” (i.e. making water sparkling) is done by mixing CO₂ and water, for example by injecting pressurised gaseous CO₂ in water. Home-use carbonation devices have become more popular in recent years. Those devices use a gas cartridge, particularly a cylinder of CO₂ under pressure to carbonate water. Depending on the size and on the level of carbonation delivered to the user, a CO₂ cylinder will last up to about 35 litres of water being carbonated. When the CO₂ cylinder is depleted, it can be replaced by a new, filled cartridge.

Home-use carbonation devices on the market are not capable of indicating a current content of the gas cartridge. Home-use carbonation devices on the market are not capable of warning when the CO₂ cylinder starts running low on CO₂ which generates frustration among users when they realise the cylinder is depleted, especially when they do not have a full CO₂ cylinder in stock.

Therefore, a carbonation device is of interest that can inform the user about the current content of a gas cartridge in use, particularly inform the user before the gas cartridge runs low. This problem is solved by the device according to claim 1. Favorable embodiments are claimed in the sub claims and described hereafter.

An aspect of the invention is related to a device for mixing a beverage with a gas, comprising a gas providing unit. The gas providing unit comprises a gas cartridge comprising a gas at a first pressure, a pressure indication device fluidically connectable with the gas cartridge, such that the first pressure prevails in the pressure indication device, and a gas line connected or connectable with the gas providing unit and configured to be connectable or connected with a liquid container, such that the gas is feedable in the liquid container via the gas line, when the gas line is connected with the gas providing unit and the liquid container, such that the beverage is mixed with the gas when the beverage resides in the liquid container. The pressure indication device is configured to be at least in a first state and in a second state, wherein the pressure indication device is in the first state, when the first pressure is above a first pre-defined threshold, indicating a high quantity of gas in the gas cartridge, and wherein the pressure indication device is in the second state, when the first pressure is below a second pre-defined threshold, indicating a low quantity of gas in the gas cartridge, such that the state of the pressure indication device indicates whether the first pressure is above or below a pre-defined threshold.

Particularly, the beverage is drinking water. The gas can be gaseous CO₂.

The gas cartridge can be cylinder filled with gaseous CO₂, also referred to as a CO₂ cylinder in the context of the present application.

The pressure indication device can be fluidically connected with the gas cartridge.

The pressure indication device can be configured such that when the pressure indication device is fluidically connected with the gas cartridge, the first pressure (prevailing in the gas cartridge) prevails in the pressure indication device. In an embodiment, the first pressure prevails in a part of the pressure indication device. The pressure indication device can be in fluid connection with the gas cartridge thereby under the pressure of the gas cartridge.

The gas line can be connected with the pressure indication device. The gas line can be connectable with the pressure indication device.

The device can be arranged and configured such that gas from the gas cartridge can pass the pressure indication device and flows into the liquid container via the gas line.

The liquid container can be configured for the uptake and/or storage of the beverage. The liquid container can comprise an inner space of the liquid container. In particular, the inner space of the liquid container can be configured for the uptake and/or storage of the beverage.

According to an embodiment, the liquid container is arranged and configured such that the beverage flows through the liquid container, particularly the inner space of the liquid container.

The liquid container can be a bottle. In an embodiment, the liquid container is a glass. In an embodiment, the liquid container is a tank. The liquid container can be a jug. According to an embodiment, the liquid container is a canister. In an embodiment, the liquid container is a section of a line, particularly a section of a fluid line. The liquid container can be a T-junction of a line, particularly a fluid line.

The liquid container can be provided to the device. In an embodiment, the liquid container can be inserted in the device. The device can comprise a receiving unit configured to receive the liquid container. In an embodiment, the liquid container is removable from the device.

The pressure indication device is in the first state, when the first pressure is above a first pre-defined threshold, indicating a high quantity of gas in the gas cartridge. The pressure indication device is in the second state, when the first pressure is below a second pre-defined threshold, indicating a low quantity of gas in the gas cartridge.

The pressure indication device can consist of or comprise a switch. The pressure indication device can have a bistable mechanism.

The pressure indication device can be configured to change its state. In an embodiment, the pressure indication device is configured to change from the first state to the second state. The pressure indication device can be configured to change its state from the second state to the first state.

In an embodiment, the first pre-defined threshold equals the second pre-defined threshold. The state of the pressure indication device can indicate whether the first pressure is above or below the pre-defined threshold, particularly whether the first pressure is above or below the first (second) pre-defined threshold. The pressure indication device can indicate when the first pressure is below the pre-defined threshold.

In an embodiment, the first pre-defined threshold is greater than the second pe-defined threshold. The device can be configured such that the state of the pressure indication device can indicate whether the first pressure is above the first pre-defined threshold. The device can be configured such that the state of the pressure indication device can indicate whether the first pressure is below the second pre-defined threshold.

An advantage of the embodiment in that the first pre-defined threshold is greater than the second pre-defined threshold is that it can be used where switching of the state of the pressure indication device is not precise. Advantageously it can also be used in a case in that there is a hysteresis making the threshold when pressure increases different from when pressure decreases. Below a known pressure (second pre-defined threshold) the device can be in the second state. Above another known pressure (first pre-defined threshold) larger than the known pressure (second pre-defined threshold), the device can be in the first state.

In an embodiment, the state of the pressure indication device can switch at a pressure between the first pre-defined threshold and the second pre-defined threshold, while the device considers the pressure to be the specific threshold value.

In an embodiment, the first pre-defined threshold is between 38 bar and 42 bar, particularly between 39 bar and 41 bar, particularly 40 bar.

In an embodiment the second pre-defined threshold is between 33 bar and 37 bar, particularly between 34 bar and 36 bar, particularly 35 bar.

The device can be configured such that if the pressure is decreasing from a pressure greater than the first pre-defined threshold (e.g. 50 bar) and makes the pressure indication device switch from the first state to the second state at a pressure smaller than the first pre-defined threshold and greater than the second pre-defined threshold (e.g. 36.5 bar), the device considers the pressure to be at the second pre-defined threshold (e.g. 35 bar).

The device can be configured such that if the pressure increases from a pressure smaller than the second pre-defined threshold (e.g. 30 bar) for instance in a situation in that the ambient temperature increases, and makes the pressure indication device switch from the second state to the first state at a pressure greater than the first pre-defined threshold (e.g. at 42 bar), the device considers the pressure to be at the first pre-defined threshold (e.g. 40 bar).

In an embodiment, the pressure indication device is connected with the gas cartridge. The gas cartridge and the pressure indication device can form a common entity.

Advantageously, the state of the pressure indication device gives an indication about the current content of gas in the gas cartridge. The first state of the pressure indication device can indicate a high current content. The second state of the pressure indication device can indicate a low current content of the gas cartridge.

In an embodiment, the gas providing unit comprises a pressure reducer configured to reduce the pressure from the first pressure to a second pressure lower than the first pressure.

The pressure reducer can be a pressure reducing valve.

The pressure reducer can be associated with the gas cartridge and can be adapted to supply gaseous CO₂ at a second pressure lower than the first pressure. The pressure reducer can be fluidically connected with the gas cartridge.

According to an embodiment, the second pressure is smaller than 20 bar, particularly smaller than 15 bar, particularly smaller than 12 bar, particularly smaller than 10 bar.

According to an embodiment, the second pressure is greater than 0.5 bar, particularly greater than 1 bar, particularly greater than 2 bar.

According to an embodiment, the first pressure is greater than 10 bar, particularly greater than 20 bar, particularly greater than 30 bar, particularly greater than 40 bar, particularly greater than 40 bar, particularly greater than 50 bar.

According to an embodiment, the first pressure is smaller than 70 bar. According to an embodiment, the first pressure is 56 bar at room temperature.

The first pressure can decrease over time when the gas providing unit is in use.

In an embodiment, the pressure reducer is configured to keep the second pressure constant when the first pressure is greater than a pre-defined critical threshold.

The device can be configured and arranged such that the gas at second pressure can be inserted in the gas line. The device can be configured and arranged such gas at the second pressure is feedable in the liquid container via the gas line and mixed with beverage when the beverage resides in the liquid container.

In an embodiment, the pressure indication device is integrated or integratable in the pressure reducer, particularly wherein the pressure indication device is integrated or integratable in a part of the pressure reducer where the first pressure prevails.

In an embodiment, the pressure indication device is integrated or integratable in the pressure reducer, particularly wherein the pressure indication device is integrated or integratable in a portion of the pressure reducer in that the first pressure prevails.

According to an embodiment, the pressure indication device is integrated in the pressure reducer, particularly wherein the pressure indication device is integrated in a part of the pressure reducer where the first pressure prevails.

According to an embodiment, the pressure indication device is integratable in the pressure reducer, particularly wherein the pressure indication device is integratable in a part of the pressure reducer where the first pressure prevails.

In the context of the present application, the part of the pressure indication device where the first pressure prevails is also referred to as high-pressure part.

The pressure indication device can be integrated in the pressure reducer such that the pressure indication device can detect the first pressure prevailing in the high-pressure part.

The pressure indication device can be integrated in the pressure reducer such that the pressure indication device can detect the first pressure prevailing in the gas cartridge.

Advantageously, the pressure indication device can detect the first pressure prevailing in the gas cartridge wherein conclusions about the current content of the cartridge can be drawn based on the detected first pressure.

The pressure indication device can be arranged and configured such that it is continuously fluidically connected with the gas cartridge. The pressure indication device can be arranged and configured such that it is fluidically connected with the gas cartridge when the device is in use, i.e. treatment of a beverage. The pressure indication device can be arranged and configured such that it is fluidically connected with the gas cartridge when the device is resting, i.e. no treatment of a beverage.

Advantageously, the pressure indication device can detect the first pressure when the device is resting which provides a more reliable determination of the first pressure.

In an embodiment, the pressure indication device is configured to determine the first pressure in real time.

In particular this means that the pressure indication device is configured to determine the first pressure during or directly after its detection.

The device can be configured such that the first pressure is determined multiple times. The device can be configured to determine the first pressure at a plurality of predefined time points. In an embodiment, the pressure indication device is configured to determine the first pressure continuously over time.

Advantageously, the accuracy of the determination of the first pressure is increased.

In an embodiment, the pressure indication device comprises an electro-mechanical switch. In an embodiment, the pressure indication device consists of an electro-mechanical switch.

The electro-mechanical switch can have a resting configuration and a pressurised configuration. The pressure indication device can have a bistable mechanism.

The pressure indication device can disconnect or connect the electrical path of an electrical circuit in response to a pressure greater than a first pre-defined threshold by shifting from the resting configuration to the pressurised configuration. For a pressure lower than another pre-defined threshold (second pre-defined threshold) lower than the first pre-defined threshold, the pressure indication device can switch from the pressurised configuration to the resting configuration.

The pressure indication device can be in a circuit-opening state at ambient pressure until the second pre-defined threshold. The pressure indication device can be in a circuit-closing state at a pressure greater than the first pre-defined threshold.

Advantageously, an electro-mechanical switch is cheap. Hence, the cost of the device is advantageously reduced.

According to an embodiment, the device comprises a first analysis device configured to determine a state of the pressure indication device, particularly to determine that the pressure indication device is in the first state or in the second state.

According to an embodiment, the device is configured to communicate with a second analysis device configured to determine a state of the pressure indication device, particularly to determine that the pressure indication device is in the first state or in the second state.

In an embodiment, the device comprises a first analysis device and the device is configured to communicate with a second analysis device, wherein the first analysis device is configured to determine a state of the pressure indication device, particularly to determine that the pressure indication device is in the first state or in the second state.

In an embodiment, the device comprises a first analysis device and the device is configured to communicate with a second analysis device, wherein the second analysis device is configured to determine a state of the pressure indication device, particularly to determine that the pressure indication device is in the first state or in the second state.

In an embodiment, the device comprises a first analysis device and the device is configured to communicate with a second analysis device, wherein the first analysis device and the second analysis device are configured to determine a state of the pressure indication device, particularly to determine that the pressure indication device is in the first state or in the second state.

In an embodiment, the device comprises an analysis assembly. The analysis assembly can comprise the first analysis device and/or the second analysis device.

The second analysis device can be an external analysis device.

The device can be configured to communicate directly with the second analysis device. The device can communicate with the second analysis device via an intermediary device.

The first analysis device and/or the second analysis device can comprise a microcontroller. The first analysis device and/or the second analysis device can comprise a processor.

The first analysis device and/or the second analysis device can be configured to execute a computer programme, comprising instructions to determine a state of the pressure indication device, particularly to determine that the pressure indication device is in the first state or in the second state.

In an embodiment, the first analysis device is arranged and configured for recording, processing and/or storage of data provided by the pressure indication device.

In an embodiment, the second analysis device is arranged and configured for recording, processing and/or storage of data provided by the pressure indication device.

In an embodiment, the first analysis device and the second analysis are arranged and configured for recording, processing and/or storage of data provided by the pressure indication device.

According to an embodiment, the first analysis device and/or the second analysis device is configured to receive data provided by the pressure indication device regarding the state of the pressure indication device. The first analysis device and/or the second analysis device can be configured to process the received data. The first analysis device and/or the second analysis device can be configured to output the received data. The first analysis device and/or the second analysis device can be configured to output the data after processing. The first analysis device and/or the second analysis device can be configured to store the received data. The first analysis device and/or the second analysis device can be configured to store the processed data.

The first analysis device and/or the second analysis device can be configured to use the received data and/or the processed data for a further analysis.

In an embodiment, the first analysis device is configured to estimate an estimated available mass of gas in the gas providing unit, particularly in the gas cartridge, based on the determined state of the pressure indication device.

According to an embodiment, the first analysis device and/or the second analysis device is configured to estimate an estimated available mass of gas in the gas providing unit, particularly in the gas cartridge, based on the determined state of the pressure indication device and/or based on user-dependent data.

In an embodiment, the first analysis device is configured to estimate an estimated available mass of gas in the gas providing unit, particularly in the gas cartridge, based on user-dependent data.

In an embodiment, the first analysis device is configured to estimate an estimated available mass of gas in the gas providing unit, particularly in the gas cartridge, based on the determined state of the pressure indication device and based on user-dependent data.

In an embodiment, the second analysis device is configured to estimate an estimated available mass of gas in the gas providing unit, particularly in the gas cartridge, based on the determined state of the pressure indication device.

In an embodiment, the second analysis device is configured to estimate an estimated available mass of gas in the gas providing unit, particularly in the gas cartridge, based on user-dependent data.

In an embodiment, the second analysis device is configured to estimate an estimated available mass of gas in the gas providing unit, particularly in the gas cartridge, based on the determined state of the pressure indication device and based on user-dependent data.

In an embodiment, the first analysis device and the second analysis device are configured to estimate an estimated available mass of gas in the gas providing unit, particularly in the gas cartridge, based on the determined state of the pressure indication device.

In an embodiment, the first analysis device and the second analysis device are configured to estimate an estimated available mass of gas in the gas providing unit, particularly in the gas cartridge, based on user-dependent data.

In an embodiment, the first analysis device and the second analysis device are configured to estimate an estimated available mass of gas in the gas providing unit, particularly in the gas cartridge, based on the determined state of the pressure indication device and based on user-dependent data.

The first analysis device and/or the second analysis device can be configured to estimate an estimated available mass of gas in the gas providing unit, particularly in the gas cartridge, based on the determined state of the pressure indication device and/or based on user-dependent data. The first analysis device and/or the second analysis device can be configured to estimate an estimated available mass of gas in the gas providing unit, particularly in the gas cartridge, based on user-dependent data. The first analysis device and/or the second analysis device can be configured to estimate an estimated available mass of gas in the gas providing unit, particularly in the gas cartridge, based on the determined state of the pressure indication device and user-dependent data.

Particularly, the estimated available mass of gas in the gas cartridge is the quantity of gas that resides in the gas cartridge when the state of the pressure indication device is determined. Particularly, the estimated available mass of gas in the gas cartridge is the quantity of gas that is available for treatments, i.e. mixing the beverage with CO₂. The estimated available mass of gas in the gas cartridge can be the current content of the gas cartridge.

Based on the state of the pressure indication device, the estimated available mass of gas can be determined. Based on the state of the pressure indication device, the estimated available mass of gas can be determined by the first analysis device and/or the second analysis device.

User-dependent data can comprise information regarding the frequency of use of the device. User-dependent data can comprise information regarding the number of liquid containers or litres which have been treated by of the device. User-dependent data can comprise information regarding the number of liquid containers or litres which have been treated by of the device since the current gas cartridge has been inserted in the device. User-dependent data can comprise information regarding the degree of carbonation. User-dependent data can comprise information regarding the quantity of CO₂ consumed when the beverage is mixed with the gaseous CO₂. User-dependent data can comprise information regarding the drinking habits of various users using the device. User-dependent data can comprise information regarding the selection of a pre-defined usage scenario of the device.

User-dependent data can be stored. User-dependent data can be stored by the first analysis device and/or by the second analysis device.

The first analysis device and/or the second analysis device can be configured such that user-dependent data is updated at regular time intervals. The first analysis device and/or the second analysis device can be configured such that user-dependent data is updated after each use of the device.

The first analysis device and/or the second analysis device can be configured to generate a usage history. The usage history can take into account user-dependent data. The usage history can take into account the determined state of the pressure indication device. In an embodiment, the first analysis device and/or the second analysis device is configured to update the usage history when the device is used. The first analysis device and/or the second analysis device can be configured to store the usage history.

The first analysis device and/or the second analysis device can be configured such that the usage history is updated at regular time intervals. The first analysis device and/or the second analysis device can be configured such that the usage history is updated after each use of the device.

According to an embodiment, the first analysis device and/or the second analysis device is configured to estimate the number of remaining liquid containers, for instance bottles, that can be treated with the present gas cartridge according to the usage history.

The device can be configured to estimate the current content of the gas cartridge based on the determined state of the pressure indication device and/or based on user-dependent data.

The device can be configured to estimate the number of remaining liquid containers, e.g. bottles, that can be treated with the present gas cartridge based on the determined state of the pressure indication device and/or based on user-dependent data.

The device can be configured to output the number of remaining liquid containers, e.g. bottles, that can be treated with the present gas cartridge. The device can be configured to output the estimated available mass of gas in the gas cartridge.

Advantageously, the device provides information about the estimated available mass of gas in the gas cartridge and/or the remaining number of liquid containers that can be treated with the present gas cartridge to the user. This information can be used to order and/or buy a new gas cartridge in due time.

According to an embodiment, the first analysis device is configured to estimate the estimated available mass of gas in the gas providing unit, particularly in the gas cartridge, based on a time elapsed since a previous use of the device.

According to an embodiment, the second analysis device is configured to estimate the estimated available mass of gas in the gas providing unit, particularly in the gas cartridge, based on a time elapsed since a previous use of the device.

According to an embodiment, the first analysis device and the second analysis device are configured to estimate the estimated available mass of gas in the gas providing unit, particularly in the gas cartridge, based on a time elapsed since a previous use of the device.

The usage history can take into account the time elapsed since a previous use of the device.

The device can be configured to estimate the remaining number of liquid containers, for instance bottles, that can be treated with the present gas cartridge based on the time elapsed since a previous use of the device.

When the device is used, the first pressure can decrease momentarily. The first pressure can increase again within a recovery time. In particular, the first pressure can increase back to the pressure level at which it was before the previous use within a recovery time.

The usage history can take into account the recovery time.

In an embodiment, the first analysis device and/or the second analysis device is configured to estimate the available mass of gas in the gas providing unit, particularly in the gas cartridge, based on a time elapsed since a previous use of the device and the recovery time. In an embodiment, the first analysis device and/or the second analysis device is configured to estimate the current content of gas in the gas cartridge based on a time elapsed since a previous use of the device and the recovery time.

The first analysis device and/or the second analysis device can be configured to estimate the available mass of gas in the gas providing unit, particularly in the gas cartridge, when the time elapsed since a previous use of the device is smaller than the recovery time. The first analysis device and/or the second analysis device can be configured to estimate the available mass of gas in the gas providing unit, particularly in the gas cartridge, when the time elapsed since a previous use of the device is greater than the recovery time. The first analysis device and/or the second analysis device can be configured to estimate the available mass of gas in the gas providing unit, particularly in the gas cartridge, when the time elapsed since a previous use of the device equals than the recovery time.

Advantageously, the reliability of the estimated available mass of gas is improved. The prognosis on the remaining number of liquid containers that can be treated with the present gas cartridge can be improved advantageously. It is advantageous to avoid triggering false alarm based on a momentary low-pressure signal while there is still enough CO₂ in the gas cylinder.

Advantageously the recovery time is adapted according to the usage history. When many liquid containers are treated sequentially in a short amount of time, the first pressure can indeed drop to a very low level and a longer recovery time will be needed.

In an embodiment, the first analysis device is configured to estimate the estimated available mass of gas in the gas providing unit, particularly in the gas cartridge, based on the time elapsed since a previous change of the state of the pressure indication device and/or based on the time elapsed between two consecutive changes in the state of the pressure indication device.

In an embodiment, the second analysis device is configured to estimate the estimated available mass of gas in the gas providing unit, particularly in the gas cartridge, based on the time elapsed since a previous change of the state of the pressure indication device and/or based on the time elapsed between two consecutive changes in the state of the pressure indication device.

In an embodiment, the first analysis device and the second analysis device are configured to estimate the estimated available mass of gas in the gas providing unit, particularly in the gas cartridge, based on the time elapsed since a previous change of the state of the pressure indication device and/or based on the time elapsed between two consecutive changes in the state of the pressure indication device.

The first analysis device and/or the second analysis device can be configured to estimate the estimated available mass of gas in the gas providing unit, particularly in the gas cartridge, based on the time elapsed since a previous change of the state of the pressure indication device. The first analysis device and/or the second analysis device can be configured to estimate the estimated available mass of gas in the gas providing unit, particularly in the gas cartridge, based on the time elapsed between two consecutive changes in the state of the pressure indication device. The first analysis device and/or the second analysis device can be configured to estimate the estimated available mass of gas in the gas providing unit, particularly in the gas cartridge, based on the time elapsed since a previous change of the state of the pressure indication device and the time elapsed between two consecutive changes in the state of the pressure indication device.

The usage history can take into account the time elapsed since a previous change of the state of the pressure indication device.

The usage history can take into account the time elapsed between two consecutive changes in the state of the pressure indication device.

The device can be configured to estimate the remaining number of liquid containers, for instance bottles, that can be treated with the present gas cartridge based on the time elapsed since a previous change of the state of the pressure indication device.

The device can be configured to estimate the remaining number of liquid containers, for instance bottles, that can be treated with the present gas cartridge based on the time elapsed between two consecutive changes in the state of the pressure indication device.

Considering the time elapsed since a previous change of the state of the pressure indication device can advantageously improve the determination of the recovery time.

Considering the time elapsed between two consecutive changes in the state of the pressure indication device can advantageously improve the determination of the recovery time.

In an embodiment, the first analysis device and/or the second analysis device is configured to estimate the available mass of gas in the gas providing unit based on the time elapsed since a previous change of the state of the pressure indication device and the recovery time.

In an embodiment, the first analysis device and/or the second analysis device is configured to estimate the available mass of gas in the gas providing unit based on the time elapsed between two consecutive changes in the state of the pressure indication device and the recovery time. In particular, the recovery time can be calibrated for a given room temperature and the difference between the time elapsed between two consecutive changes and the recovery time can give an indication of the actual temperature of the room where the device is used. The room temperature can modify the density of the gas and thereby change the remaining number of liquid containers that can be treated. Retrieving the room temperature based on this difference can also be used to adjust the operating parameters of the device so that carbonation of the beverage is constant and in particular independent of the room temperature.

Advantageously, the reliability of the estimated available mass of gas can be improved. It is advantageous to avoid triggering false alarm based on momentary a low pressure signal while there is still enough CO₂ in the gas cylinder.

An embodiment is characterised in that the device is configured to output a signal, when the estimated available mass of gas in the gas providing unit is smaller than a pre-defined value.

An embodiment is characterised in that the device is configured to output a signal, when the estimated available mass of gas in the gas cartridge is smaller than a pre-defined value.

According to an embodiment, the device is configured to output a signal when the pressure indication device switches from the first state to the second state. According to an embodiment, the device is configured to output a signal when the pressure indication device switches from the first state to the second state and remain in the second state for a time longer than the recovery time. According to an embodiment, the device is configured to output a signal when the pressure indication device is in the second state.

In an embodiment, the device is configured to output a signal when the cartridge runs empty.

The pre-defined value can be updated based on user-dependent data. The pre-defined value can be update based on the usage history.

In an embodiment, the device is configured to output a signal, when the remaining number of liquid containers that might be treated with the remaining estimated available mass of gas in the gas providing unit is below a pre-defined number.

The device can be configured to output the signal in due time such that the user has time to order and/or buy a new (full) cartridge. Advantageously, the user friendliness is increased because the user is not surprised by an empty cartridge but has sufficient time to order a new one in time.

In an embodiment, the device is configured to output a signal, when the first pressure drops below a pre-defined value. In an embodiment, the device is configured to output a signal, when the first pressure is below a pre-defined value. In an embodiment, the device is configured to output a signal, when the first pressure is smaller than 40 bar. In an embodiment, the device is configured to output a signal, when the first pressure is smaller than 35 bar.

In an embodiment, the device is configured to output a signal, when the remaining estimated available mass is below a pre-defined value. The pre-defined value can be smaller than 33% (of the maximum available mass). In an embodiment, the pre-defined value is 25% (of the maximum available mass).

In an embodiment, the device is configured to output a signal, when the number of remaining liquid containers, particularly bottles, that can be treated using the cylinder is below a pre-defined value. The pre-defined value can be smaller than 10 liquid containers. In an embodiment, the pre-defined value is 5 liquid containers, particularly 5 bottles.

The device can be configured such that when the cylinder runs low, the device outputs a signal indicating that the cylinder runs low. The device can be configured such that when the cylinder is empty, the device outputs a further signal indicating that the cylinder is empty. The signal indicating the empty cartridge can differ from the signal indicating that the cartridge is running low.

In an embodiment, the device is configured to output a signal, when the estimated available mass of gas in the gas providing unit, particularly in the gas cartridge, is smaller than a pre-defined value and a time elapsed since a previous use of the device is longer than a pre-defined recovery time.

Taking into account the pre-defined recovery time can advantageously reduce the probability of a false signal, when the device is in use multiple times within the time period of the recovery time.

Advantageously, the reliability of the output of the signal is increased.

In an embodiment, the device comprises an external device or the device is configured to communicate with the external device, wherein the external device is configured to receive a signal and/or data of the device and wherein the external device is configured to initiate a subsequent process, particularly wherein the subsequent process comprises at least one of:
initiating an order of a new gas cartridge,
switching a light on,
switching a light off,
showing a text,
sending a text message,
activating an application.

In an embodiment, the external device is configured to initiate a subsequent process, when the estimated available mass of gas in the gas providing unit drops below a pre-defined value. In an embodiment, the external device is configured to initiate a subsequent process, when the estimated available mass of gas in the gas providing unit is below a pre-defined value. In an embodiment, the device is configured such that the external device is configured to initiate a subsequent process, when the cartridge runs empty.

Advantageously, the device is configured such that the user is informed by a subsequent process in time when the quantity of gas in the cartridge is below a pre-defined value, particularly when the cartridge runs empty. Advantageously, this increases the user's satisfaction since the user is informed in due time that the cartridge runs empty such that the user can act accordingly (for instance order a new cartridge).

The external device can be configured to communicate with the device. The external device can be connectable with the device. The external device can be connected with the device. The external device can be comprised in the device. The external device can be connectable with the first analysis device and/or the second analysis device. The external device can be connected with the first analysis device and/or with the second analysis device. The external device can be configured to communicate with the first analysis device and/or with the second analysis device. The external device can be configured to communicate with the pressure reducer.

The external device can be configured to receive data from the first analysis device and/or the second analysis device. The external device can be configured to receive processed data from the first analysis device and/or the second analysis device.

The external device can comprise a microcontroller configured to initiate a subsequent process. The external device can comprise a processor configured to initiate a subsequent process. The external device can be configured to execute a computer programme, comprising instructions to initiate a subsequent process.

In an embodiment, said subsequent process initiate an order of a new gas cartridge considering the usage history.

In an embodiment, the external device is a computing device of the user. The external device can be a mobile computing device. The external device can be a smart phone. The external device can be a smart watch. The external device can be a tablet.

In an embodiment, the external device is a computing device at the distribution company.

In an embodiment, the device is a configured for an automatic reordering of a new cartridge. Advantageously, the user does not need to spent time to order new cartridges in time. Advantageously, the user-friendliness of the device is increased.

In an embodiment, said subsequent process initiate an order of a new gas cartridge based on the amount of gas cartridges consumed since the last order.

The reorder of a new cartridge can take into account the number of cartridges in the stock. In an embodiment, the device is a configured for an automatic reordering of a new cartridge or a plurality of new cartridges. A plurality of cartridges can be a bundle of cartridges.

An advantage is that also a user that creates a stock of cartridges can benefit from the automatic reordering. An advantage is that also a user that buys and/or orders a plurality of cartridges can benefit from the automatic reordering.

The reorder of a new cartridge can take into account an estimated delivery time of a new cartridge or bundle of cartridges to the user.

In an embodiment, the device comprises a further gas line, wherein the further gas line is connected or connectable with the gas providing unit and fluidically connected with the fluid line such that the gas is feedable in the fluid line via the further gas line upstream of the carbonation to acidify the beverage flowing through the liquid line.

In an embodiment, the beverage is mineralised upon acidification.

In the following, further features, advantages and embodiments of the present invention are explained with reference to the Figures, wherein

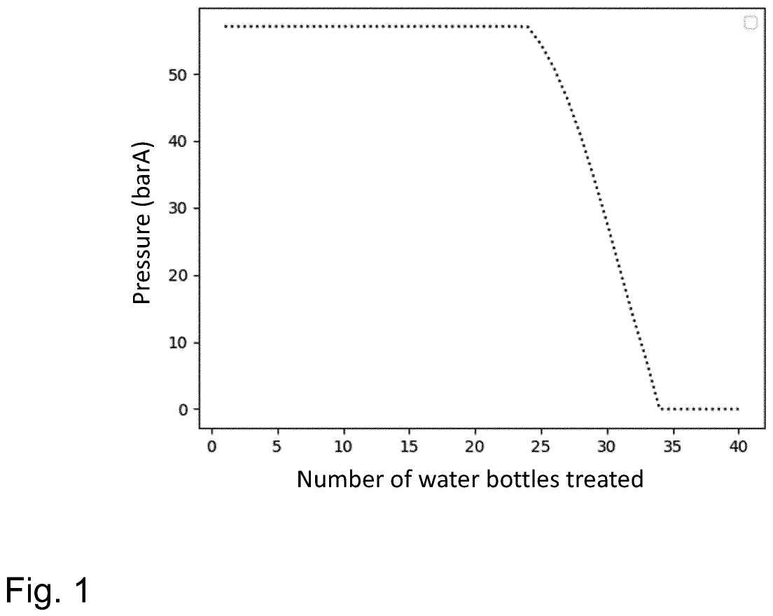

FIG. 1 shows the pressure in a gas cartridge at room temperature,

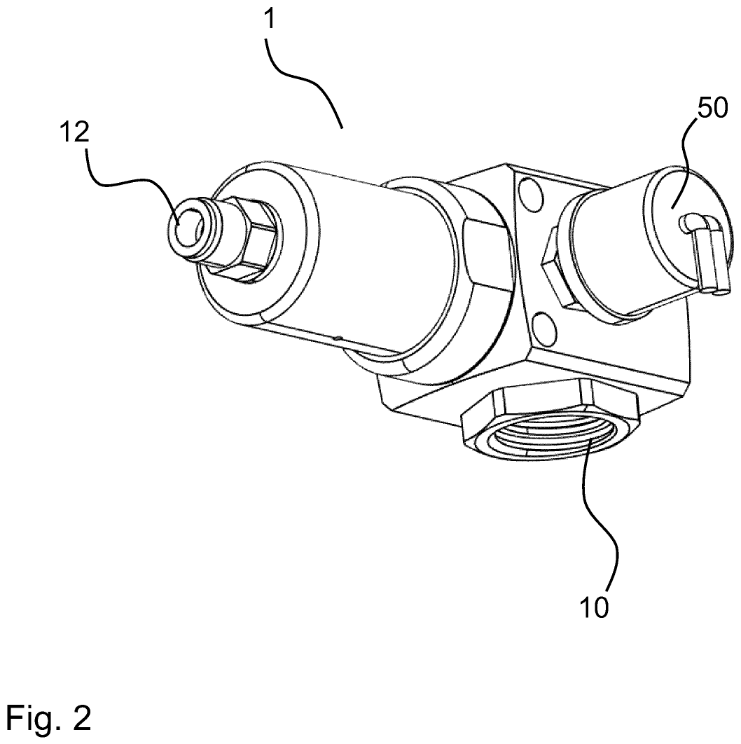

FIG. 2 shows a perspective view of a pressure reducer,

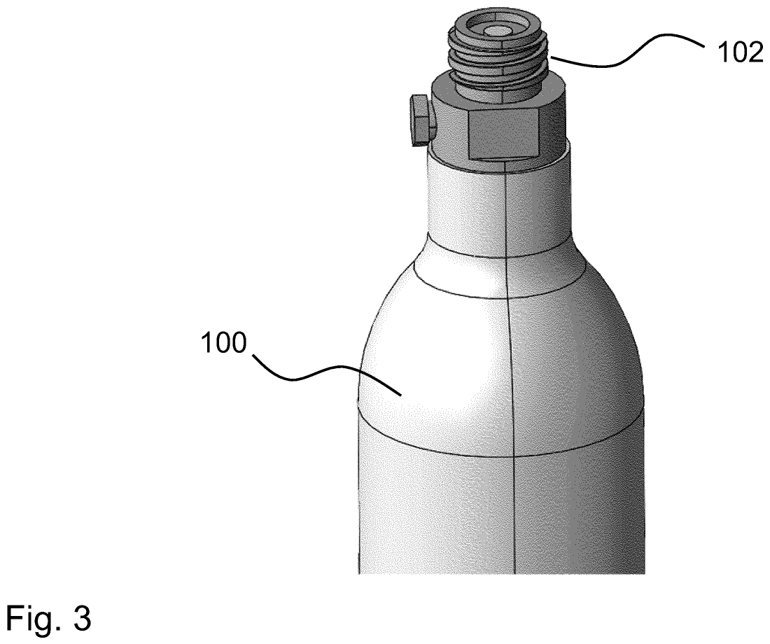

FIG. 3 shows an illustration of a gas cartridge with a valve,

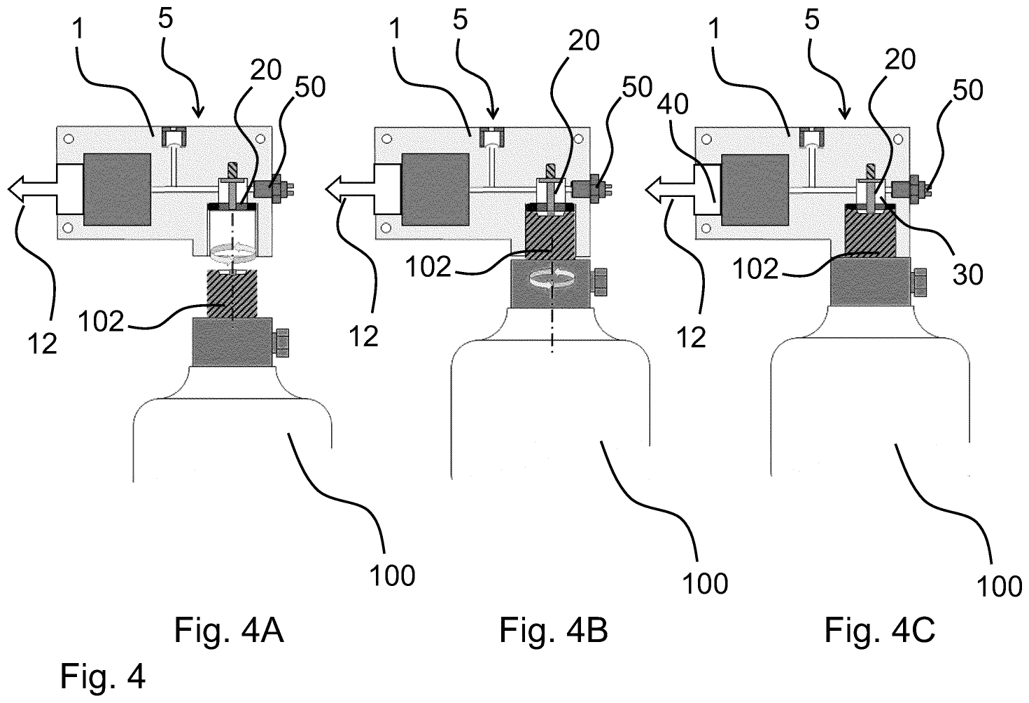

FIG. 4 illustrates a pressure reducer with the docking of a gas cartridge,

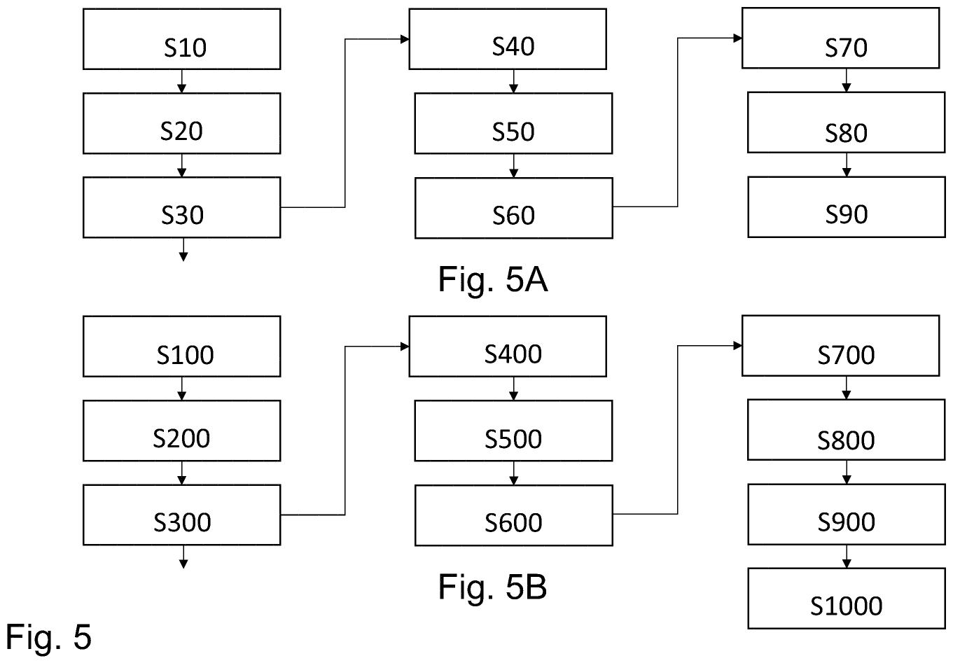

FIG. 5 shows two exemplary flowcharts of a replenishment logic,

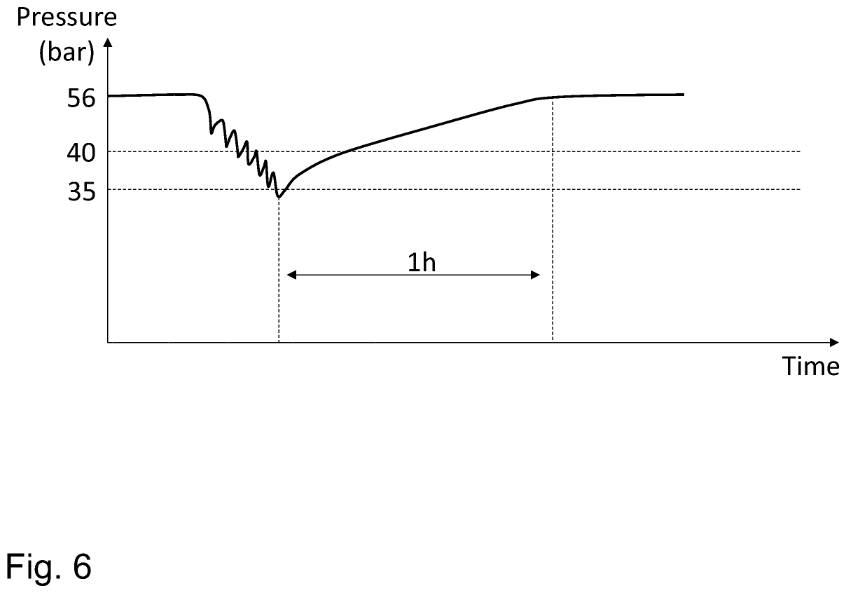

FIG. 6 shows the effect of carbonation events on the pressure inside the gas cartridge,

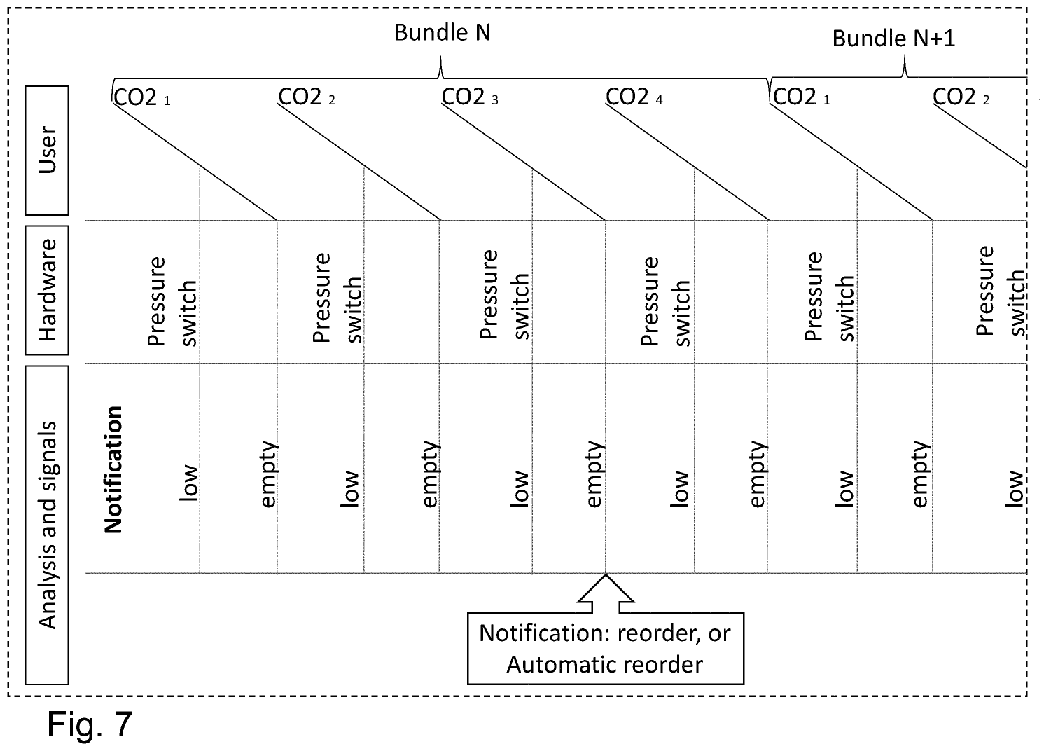

FIG. 7 shows a schematic flow of an exemplary replenishment method,

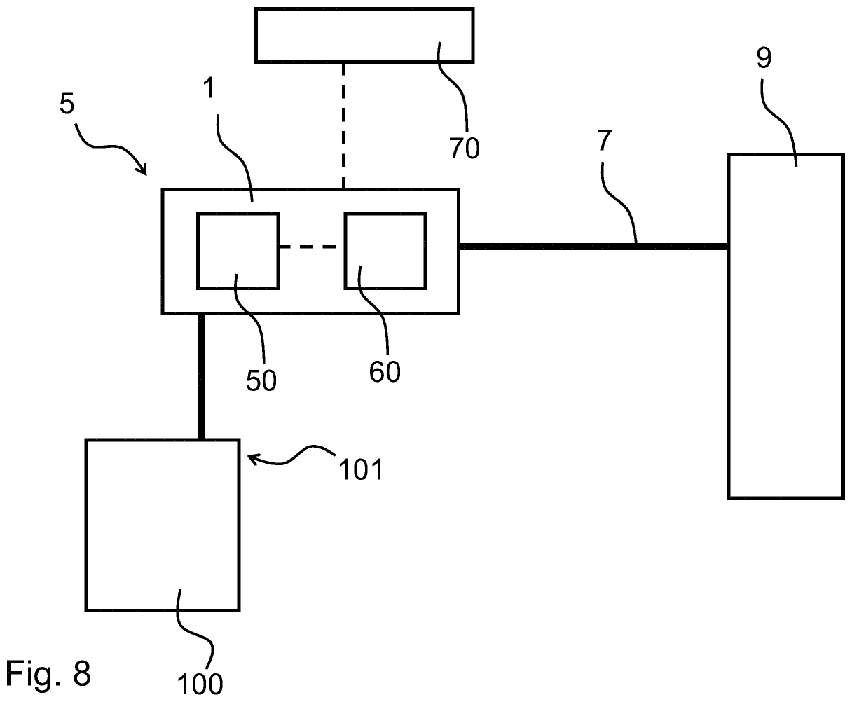

FIG. 8 shows a schematic representation of an embodiment of the device according to the invention,

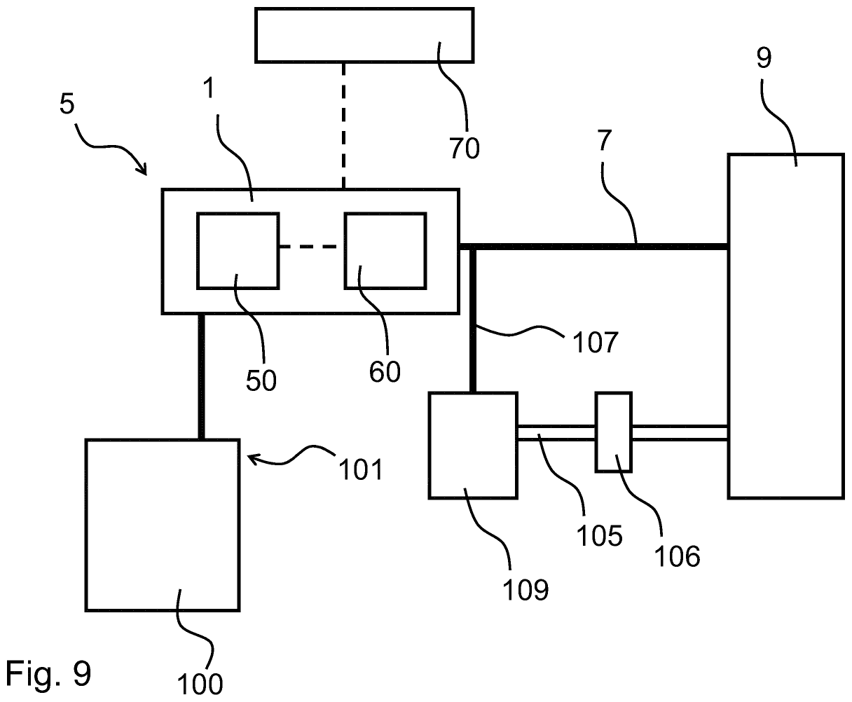

FIG. 9 shows a schematic representation of a further embodiment of the device according to the invention,

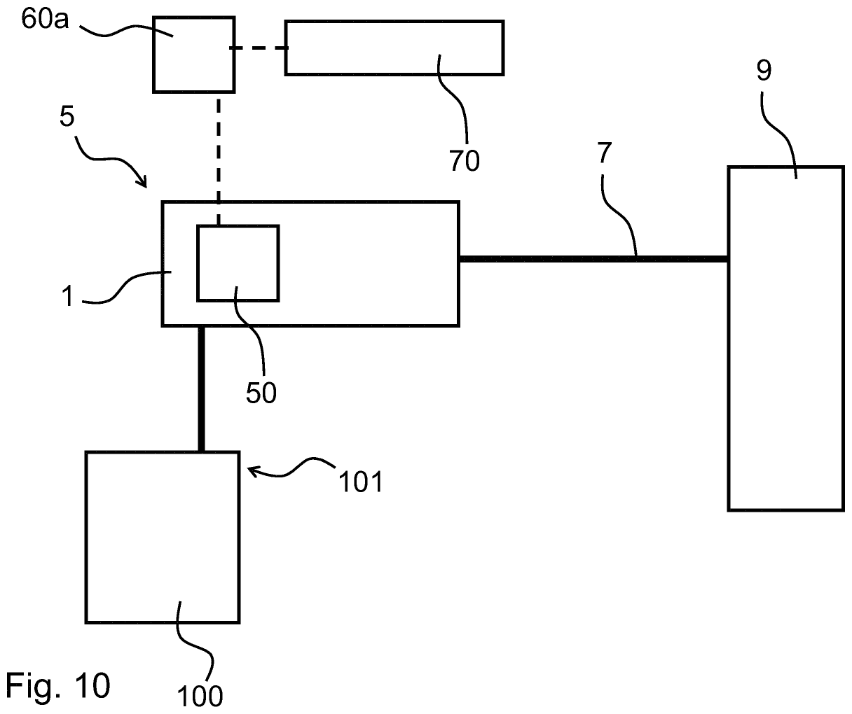

FIG. 10 shows a schematic representation of a further embodiment of the device according to the invention.

FIG. 1 illustrates the drop of the pressure in the gas cartridge, particularly the CO₂ cylinder, dependent on the number of bottles, i.e. number of treatments, at a room temperature of 20° C. At room temperature, a full CO₂ cylinder can have a pressure of 56 bar. For a stable ambient temperature, this pressure can remain stable as long as liquid CO₂ is inside the cylinder, CO₂ is indeed typically stored in a diphasic state. For a stable ambient temperature, this pressure can remain in a steady state as long as liquid CO₂ is inside the cylinder. Afterwards, the pressure in the CO₂ cylinder decreases due to a consumption of CO₂ (treatment).

If the ambient temperature varies, however, the pressure can vary, too.

The first pre-defined threshold can be selected such that it is not too close to the 56 bar (pressure of CO₂ cylinder at room temperature). If the threshold is selected to be 50 bar for example, a full gas cartridge would trigger a switch in the pressure indication device for a room temperature of 10° C. for example, which might confuse the user. Signaling that the cylinder is almost depleted must therefore not be based on a pressure level too close from the pressure of a full cylinder under various temperatures that can occur in a kitchen. Yet, the pressure level triggering the signal should not be too low, otherwise there might not be enough time to ship a new gas cartridge.

In FIG. 2, a perspective view of a pressure reducer 1 is shown. In the illustrated embodiment, the pressure indication device 50 is integrated in pressure reducer 1. The pressure reducer 1 can comprise a high-pressure part. The pressure reducer 1 can comprise a low-pressure part. The pressure indication device 50 can be integrated in the high-pressure part. The pressure indication device 50 can be connected fluidically with the high-pressure part. The pressure indication device 50 can be arranged and configured to determine the pressure in the high-pressure part of the pressure reducer 1.

The pressure reducer 1 can comprise a first connection unit 10 for connecting the pressure reducer 1 with a gas cartridge (also referred to as CO₂ cylinder or cylinder in the context of the application). The pressure reducer 1 can comprise a second connection unit 12 for connecting the pressure reducer 1 with a gas line.

FIG. 3 illustrates an embodiment of a gas cartridge 100 comprising a valve 102. In FIG. 4, an example of the docking of a pressure reducer 1 and a gas cartridge 100 is shown.

The pressure reducer 1 can comprise a pin 20. The pin 20 can be configured to be insertable in the valve 102 of the gas cartridge 100. The pin 20 can be configured such that as long as the pin 20 is inserted in the valve 102 it keeps open the valve 102 continuously.

The pressure reducer 1 can comprise a high-pressure part 30 (high-pressure portion 30). The pressure reducer 1 can comprise a low-pressure part 40 (low-pressure portion 40). The pressure reducer 1 can comprise or be connected fluidically with a pressure indication device 50. The pressure indication device 50 can be configured to determine the first pressure prevailing in the high-pressure part 30 of the pressure reducer 1.

The first pressure that can prevail in the gas cartridge 100 also can prevail in the high-pressure part 30 of the pressure reducer 1, when the valve 102 is connected with the pressure reducer 1. Hence, the measurement of the first pressure in the high-pressure part 30 of the pressure reducer 1 can provide the first pressure prevailing in the gas cartridge 100. The measurement of the first pressure in the high-pressure part 30 of the pressure reducer 1 can be considered as an indication for the first pressure prevailing in the gas cartridge 100. The measurement of the first pressure in the high-pressure part 30 of the pressure reducer 1 can be considered as an indirect measurement of the first pressure prevailing in the gas cartridge 100.

The valve 102 can be open continuously such that the first pressure can be determined when the device 5 is not in use to treat a beverage. When the device 5 is in use, the first pressure can drop at least temporarily. Hence, a measurement of the first pressure during the treatment, exclusively, is less precise and less reliable to determine the first pressure.

In FIG. 5 (FIG. 5A and FIG. 5B), two examples of a flow chart are provided, each describing a possible sequence of steps carried out by the first analysis device and/or the second analysis device and/or external device according to a possible situation of the device 5.

In FIG. 5A, an exemplary process is illustrated for a situation where the first pressure is starting to decrease beyond the second state of the pressure indication device. Here a verification that the second state of the pressure indication device lasts beyond the recovery time is performed, which means that the pressure will remain below the threshold defining the second state of the pressure indication device. In this situation however, the gas cartridge still contains enough gas to treat several liquid containers and no signal urging the user to change the gas cartridge is required. The device only outputs the estimated number of liquid containers that can be treated before the gas cartridge is empty.

The illustrated steps of the illustrated embodiment are as follows: S10 Estimation started; S20 Check state of pressure indication device; S30 Pressure indication device is in second state (low); S40 Check previous state of pressure indication device; S50 Previous state was first state (high); S60 Check time passed since previous use; S70 Time is greater than recovery time; S80 Iterate counter of number of liquid containers treated with current gas cartridge; S90 Signal remaining number of liquid containers that can be treated with the current gas cartridge.

In FIG. 5B, an exemplary process is described where the gas cartridge is almost empty, and the user only has enough gas cartridges to last until a shipment of new cartridges is delivered. Also, in this situation, the user has subscribed to an automatic reorder service.

The illustrated steps of the illustrated embodiment are as follows: S100 Estimation started; S200 Check state of pressure indication device; S300 Pressure indication device is in second state (low); S400 Check previous state of pressure indication device; S500 Previous state was also second state (low); S600 Check estimated number of liquid containers that can be treated; S700 Previous number is lower than or equal to a pre-defined value; S800 Check estimated number of full gas cartridges in possession of the user; S900 Previous number is lower than or equal to a pre-defined value; S1000 Trigger automatic reorder of gas cartridges.

The depletion of the usable CO₂ gas inside of the CO₂ cylinder (gas cartridge) is key to an automatic ordering of a new cartridge, in particular automatic ordering of a new cartridge based on the state of the pressure indication device, particularly automatic ordering of a new cartridge based on the state of the pressure indication device and considering the usage history. The depletion of the usable CO₂ gas inside of the CO₂ cylinder is key to an automatic ordering of a new cartridge, in particular automatic ordering of a new cartridge based on the state of the pressure indication device and the recovery time. The process is also referred to as “Smart Replenishment” (SR) in the context of this application. The depletion detection can be achieved with the pressure indication device. Particularly, the pressure indication device is installed on the high-pressure part of the pressure reducer in order to detect when the amount of CO₂ inside of the cylinder is running low, as indicated by the pressure inside of the cylinder. In an embodiment, the gas cartridge is considered to run low, when the first pressure is below 35 bar. However, the pressure indication device reading is an indirect measure of the true fill state of the cylinder and depends on the previous state, therefore the Smart Replenishment process requires non-trivial logic.

Key points to consider for the process can be:

The cylinder can be at 56 bar (at 20° C.) nominal pressure prior to dispense. CO₂ in the cylinder is partially in liquid form, therefore upon dispense of the CO₂ gas from the cylinder, pressure inside can decrease momentarily. The liquid phase then boils off until nominal pressure is achieved again, and the cylinder is in the recovered state. The pressure will recover its equilibrium level once the cylinder reaches thermal equilibrium with the room. (see FIG. 6).

The first pressure in the cylinder can drop about 3 bar with each high carbonation cycle (which uses about 15 g of CO₂), but can return back to nominal 56 bar inside of the cartridge following a log like curve within about 1 hour (depending on the ambient temperature), with the first 2 bar increase within 20 minutes.

If 6-7 high carbonation processes are run in a row without recovery, spaced a few minutes apart, the pressure indication device may be triggered, even though there is still sufficient (albeit in unusable liquid phase) CO₂ in the cylinder. Recovery time to switch above the pressure switch trigger (increase in pressure by 5 bar) takes around 10 minutes at 20° C., FIG. 6. Recovery to nominal 56 bar again takes about 1 hour, FIG. 6.

During normal operation (cylinder full and in recovered state), the pressure indication device can read high before and after dispense. The device can be configured such that the first time the pressure indication device reads low (while machine is in recovered state) it can indicate low CO₂ in the cylinder. In an embodiment, it triggers automatic ordering of a new (full) cartridge or a new bundle of cylinders.

FIG. 7 illustrates an example of appearing events when the user uses a plurality of cylinders. Exemplarily, the events are shown for a bundle of four cylinders. The device can be configured to take the number of cartridges in stock into account, particularly when automatic reordering is considered.

The device can be configured such that when the first cylinder of the bundle runs low, the device outputs a signal that the cylinder runs low. The device can be configured such that when the first cylinder of the bundle is empty, the device outputs a further signal, particularly different from the signal that the cylinder runs low, that the cylinder is empty.

The device can be configured such that when the second cylinder of the bundle runs low, the device outputs a signal that the cylinder runs low. The device can be configured such that when the second cylinder of the bundle is empty, the device outputs a further signal, particularly different from the signal that the cylinder runs low, that the cylinder is empty.

The device can be configured such that when the third cylinder of the bundle runs low, the device outputs a signal that the cylinder runs low. The device can be configured such that when the third cylinder of the bundle is empty, the device outputs a further signal, particularly different from the signal that the cylinder runs low, that the cylinder is empty.

The device can be configured such that when the third cylinder of the bundle is empty the device outputs an additional signal indicating that a new bundle should be ordered. In an embodiment the device is configured such that when the third cylinder of the bundle is empty the device initiates a subsequent process, in particular an automatic order of a cartridge or a bundle of cartridges.

The device can be configured such that when the fourth cylinder of the bundle runs low, the device outputs a signal that the cylinder runs low. The device can be configured such that when the fourth cylinder of the bundle is empty, the device outputs a further signal, particularly different from the signal that the cylinder runs low, that the cylinder is empty.

FIG. 8, FIG. 9, and FIG. 10 show schemes of different embodiments of the device 5. The device 5 can comprise a gas providing unit 101. The device 5 can comprise a gas cartridge 100. The gas cartridge 100 can be comprised in the gas providing unit 101. The device 5 can comprise or be connected to a liquid container 9.

The illustrated devices 5 comprise a pressure reducer 1. The pressure reducer 1 can be fluidically connected with the gas cartridge 100.

The pressure reducer 1 can comprise a pressure indication device 50. The pressure reducer 1 can comprise a first analysis device 60 (FIG. 8, FIG. 9). The first analysis device 60 can be configured to communicate with the pressure indication device 50 (FIG. 8, FIG. 9).

The device 5 can comprise a second analysis device 60a (FIG. 10). The second analysis device 60a can be configured to communicate with the pressure indication device 50 (FIG. 10).

The device 5 can comprise an external device 70. The device 5 can be configured such that the pressure reducer 1 can communicate with the external device 70. In an embodiment, first analysis device 60 is configured to communicate with the external device 70. In an embodiment, the second analysis device 60a is configured to communicate with the external device 70 (FIG. 10).

The device 5 can comprise a gas line 7. The device 5 can be arranged and configured such that gas from the cylinder 100 can pass the pressure reducer 1 and flow via the gas line 7 in the liquid container 9.

In an embodiment, the device can comprise a further gas line 107, wherein the further gas line 107 which is connected or connectable with the pressure reducer 1. The device 5 can comprise a further liquid container 109, which is fluidically connected or connectable with the further gas line 107. The device 5 can be arranged and configured such that an acidification of liquid residing in the further liquid container 109 can occur. The further liquid container 109 can be connected or be connectable to the liquid container 9 via a fluid line 105. The device 5 can comprise a mineralisation unit 106. The fluid can flow from the further liquid container to the liquid container 9 through the mineralisation unit 106. The device 5 can be arranged and configured such that the beverage can be mineralised prior to carbonation of the beverage in the liquid container 109 (FIG. 9).

1. A device (5) for mixing a beverage with a gas, comprising
a gas providing unit (101), comprising
a gas cartridge (100) comprising a gas at a first pressure,
a pressure indication device (50) fluidically connectable with the gas cartridge (100), such that the first pressure prevails in the pressure indication device (50),
a gas line (7) connected or connectable with the gas providing unit (101) and configured to be connectable or connected with a liquid container (9), such that the gas is feedable in the liquid container (9) via the gas line (7), when the gas line (7) is connected with the gas providing unit (101) and the liquid container (9), such that the beverage is mixed with the gas when the beverage resides in the liquid container (9),
wherein the pressure indication device (50) is configured to be at least in a first state and in a second state,
wherein the pressure indication device (50) is in the first state, when the first pressure is above a first pre-defined threshold, indicating a high quantity of gas in the gas cartridge (100), and
wherein the pressure indication device (50) is in the second state, when the first pressure is below a second pre-defined threshold, indicating a low quantity of gas in the gas cartridge (100),
such that the state of the pressure indication device (50) indicates whether the first pressure is above or below a pre-defined threshold.

2. The device (5) according to claim 1, characterised in that the gas providing unit (101) comprises a pressure reducer (1) configured to reduce the pressure from the first pressure to a second pressure lower than the first pressure.

3. The device (5) according to claim 2, characterised in that the pressure indication device (50) is integrated or integratable in the pressure reducer (1), particularly wherein the pressure indication device (50) is integrated or integratable in a part of the pressure reducer (1) where the first pressure prevails.

4. The device (5) according to claim 1, characterised in that the pressure indication device (50) is configured to determine the first pressure in real time.

5. The device (5) according to claim 1, characterised in that the pressure indication device (50) comprises or consists of an electro-mechanical switch.

6. The device (5) according to claim 1, characterised in that the device (5) comprises a first analysis device (60), wherein the first analysis device (60) is configured to determine a state of the pressure indication device (50), particularly to determine that the pressure indication device (50) is in the first state or in the second state, or in that the device (5) is configured to communicate with a second analysis device (60a), wherein the second analysis device (60a) is configured to determine a state of the pressure indication device (50), particularly to determine that the pressure indication device (50) is in the first state or in the second state, or in that the device (5) comprises a first analysis device (60) and in that the device (5) is configured to communicate with a second analysis device (60a), wherein the first analysis device (60) is configured to determine a state of the pressure indication device (50), particularly to determine that the pressure indication device (50) is in the first state or in the second state and/or wherein the second analysis device (60a) is configured to determine a state of the pressure indication device (50), particularly to determine that the pressure indication device (50) is in the first state or in the second state.

7. The device (5) according to claim 6, characterised in that the first analysis device (60) and/or the second analysis device (60a) is arranged and configured for recording, processing and/or storage of data provided by the pressure indication device (50).

8. The device (5) according to claim 6, characterised in that the first analysis device (60) and/or the second analysis device (60a) is configured to estimate an estimated available mass of gas in the gas providing unit (101), particularly in the gas cartridge (100), based on the determined state of the pressure indication device (50) and/or based on user-dependent data.

9. The device (5) according to claim 6, characterised in that the first analysis device (60) and/or the second analysis device (60a) is configured to estimate the estimated available mass of gas in the gas providing unit (101), particularly in the gas cartridge (100), based on a time elapsed since a previous use of the device (5).

10. The device (5) according to claim 6, characterised in that the first analysis device (60) and/or the second analysis device (60a) is configured to estimate the estimated available mass of gas in the gas providing unit (101), particularly in the gas cartridge (100), based on the time elapsed since a previous change of the state of the pressure indication device (50) and/or based on the time elapsed between two consecutive changes in the state of the pressure indication device (50).

11. The device (5) according to claim 6, characterised in that the device (5) is configured to output a signal, when the estimated available mass of gas in the gas providing unit (101), particularly in the gas cartridge (100), is smaller than a pre-defined value.

12. The device (5) according to claim 6, characterised in that the device (5) is configured to output a signal, when the estimated available mass of gas in the gas providing unit (101), particularly in the gas cartridge (100), is smaller than a pre-defined value and a time elapsed since a previous use of the device (5) is longer than a pre-defined recovery time.

13. The device (5) according to claim 6, characterised in that the device (5) comprises an external device (70) or the device (5) is configured to communicate with the external device (70), wherein the external device (70) is configured to receive a signal and/or data of the device (5) and wherein the external device (70) is configured to initiate a subsequent process, particularly wherein the subsequent process comprises at least one of:
initiating an order of a new gas cartridge (100),
switching a light on,
switching a light off,
showing a text,
sending a text message,
activating an application.

14. The device (5) according to claim 13, characterised in that said subsequent process initiate an order of a new gas cartridge (100) based on the amount of gas cartridges (100) consumed since the last order.

15. The device (5) according to claim 1, characterised in that the device (5) comprises a further gas line (107), wherein the further gas line (107) is connected or connectable with the gas providing unit (101) and fluidically connected with a fluid line (105) such that the gas is feedable in the fluid line (105) via the further gas line (107) upstream of the carbonation to acidify the beverage flowing through the liquid line (105).
